(19) United States
(12) Patent Application Publication
(10) Pub. No.: US 2006/0095357 A1
(43) Pub. Date: May 4, 2006

(54) Wireless payment processing

(75) Inventors: Marcellino Tanumihardja, Lynnwood, WA (US); Gregory A. Brown, Renton, WA (US)

Correspondence Address: SEARETE LLC;CLARENCE T. TEGREENE, 1756 - 114TH AVE., S.E., SUITE 110, BELLEVUE, WA, 98004, US

(73) Assignee: Remote Sales LLC, a limited liability corporation of the State of Nevada

(21) Appl. No.: 11/251,553

(22) Filed: Oct. 14, 2005

Related U.S. Application Data
(63) Continuation-in-part of application No. 09/894,274, filed on Jun. 27, 2001.
(60) Provisional application No. 60/282,381, filed on Apr. 5, 2001.

(51) Int. Cl. G06Q 40/00

(52) U.S. Cl. 705/35

(57) ABSTRACT

In one embodiment, a method includes but is not limited to authorizing at least one payment transaction wherein authorization is effected by user input to a computational entity through a wireless device. In addition to the foregoing, other method embodiments are described in the claims, drawing, and text forming a part of the present application. In one or more various embodiments, related systems include but are not limited to circuitry for effecting the foregoing-described method embodiments; the circuitry can be virtually any combination of hardware, software, and/or firmware configured to effect the foregoing-described method embodiments depending upon the design choices of the system designer.

### CROSS-REFERENCE(S) TO RELATED APPLICATION(S)

This patent application hereby incorporates by reference in its entirety the pending Provisional Patent Application entitled MANAGED MESSAGING PLATFORM, Application No. 60/282,381, naming Marcellino Tanumihardja and Gregory Brown as inventors, filed via Express Mail on 5 Apr. 2001, and also claims the benefit of this Provisional Patent Application No. 60/282,381 under the auspices of 35 U.S.C. 119(e).

### FIELD OF THE INVENTION

The present application relates, in general, to wireless communication.

### BACKGROUND OF THE INVENTION

Wireless communication refers to communication between sending and receiving stations via electromagnetic radiation not guided by any hard physical path (e.g., by microwave link). Examples of wireless communication are communication via cellular telephony systems, Personal Communication Systems, or Global System for Mobile Communication systems.

Wireless communication is typically accomplished via users exchanging voice and/or alphanumeric data via use of at least one wireless device. One example of wireless communication is that of a first wireless-device user exchanging voice and/or alphanumeric data with a group of two or more other wireless-device users.

It has been noted by the inventors named herein (the inventors) that when a first wireless-device user finds it advantageous to exchange voice and/or alphanumeric data with a group of wireless-device users, the first wireless-device user may want to disseminate information to the group, or may instead want to both disseminate information to the group and receive feedback from the group members in response to the disseminated information. It has been further noted by the inventors that when such group communication is performed in the related art, it is generally done manually, in that the first wireless-device user must generally contact each of the group members and disseminate the voice and/or alphanumeric data on an individual basis. Thereafter, typically the first wireless-device user manually aggregates and transforms the responses from the users in the group if such aggregation or transformation is desired.

The inventors have noted that there are several disadvantages to the manual method of the related art. First, the inventors have noted that it is very tedious and time intensive to contact and disseminate information to the group, particularly if data transmission is involved. Second, the inventors have noted that insofar as group members may be temporarily unavailable, the first wireless-device user must seek to repetitively call the unavailable group members. Third, the inventors have noted that it is very tedious and time intensive to manually aggregate and transform responses from the group members. Fourth, the inventors have noted that if a group member is not interested in either receiving or responding to the disseminated information, the first wireless-device user essentially wastes his time by contacting the disinterested user. Fifth, the inventors have noted that if a group member is undecided in his response to the disseminated information, the first wireless-device user must repetitively contact such undecided group member to see if the undecided group member has yet arrived at a decision. In addition to the foregoing, other disadvantages exist which will be appreciated by those having ordinary skill in the art.

It has been noted by the inventors that one particularly useful type of wireless-device-related information dissemination and subsequent aggregation relates to payment transactions. For example, suppose that (a) a political entity (e.g., a first wireless device user) desires to hold a fund-raising dinner for a certain amount of money per plate (e.g., fifty dollars per plate), and that (b) the political entity has a list of wireless-device-using potential donors each of which to whom the political entity would like to extend fund-raising dinner invitations, In the related art, the political entity would need to have (a) manually contacted each person on the list of potential donors about the fund-raising dinner, (b) recorded the response of each potential donor, and, (c) for each potential donor who indicated a willingness to pay the fee and attend the fund-raising dinner, record the payment transaction and identity information for each political donor. Those having ordinary skill in the art will appreciate that the foregoing only constitutes one example of wireless-device-related payment transactions, and that many other types of wireless-device-related payment transactions exist, such as concerts, lotteries, and direct solicitation for donations, loans, stock subscription, etc.

It has been noted by the inventors that the related-art methods and systems for engaging in wireless-device-related payment transactions are highly labor-intensive and tedious. Accordingly, the inventors have posited that in light of the high degree of utility deriving from payment transactions via wireless devices, and in light of the highly labor intensive nature of the related-art methods and systems related to payment transactions via wireless devices, it would be advantageous to have methods and systems which provide automatic payment transactions via use of at least one wireless device.

### SUMMARY OF THE INVENTION

The inventors have devised methods and systems that will allow automatic payment transactions via use of at least one wireless device.

In one embodiment, a method includes but is not limited to authorizing at least one payment transaction wherein authorization is effected by user input to a computational entity through a wireless device. In addition to the foregoing, other method embodiments are described in the claims, drawing, and text forming a part of the present application.

In one or more various embodiments, related systems include but are not limited to circuitry for effecting the foregoing-described method embodiments; the circuitry can be virtually any combination of hardware, software, and/or firmware configured to effect the foregoing-described method embodiments depending upon the design choices of the system designer.

The foregoing is a summary and thus contains, by necessity; simplifications, generalizations and omissions of detail; consequently, those skilled in the art will appreciate that the summary is illustrative only and is not intended to be in any way limiting. Other aspects, inventive features, and advantages of the devices and/or processes described herein, as defined solely by the claims, will become apparent in the non-limiting detailed description set forth herein.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a pictographic representation of an environment wherein methods and systems described herein may be utilized.

FIG. 2 shows a high-level logic flowchart depicting a process in authorizing at least one payment transaction wherein authorization is effected by user input to a computational entity through a wireless device.

FIG. 3 shows two alternate implementations of the high-level logic flowchart shown in FIG. 2. Depicted in FIG. 3 is that, in one implementation, method step 202 includes method step 300; further depicted is that, in another implementation, method step 202 includes method step 302.

FIG. 4 show two alternate implementations of the high-level logic flowchart shown in FIG. 2. Depicted in FIG. 4 is that, in one implementation, method step 202 includes method step 400; further depicted is that, in another implementation, method step 202 includes method step 402.

FIG. 5 depicts that, in one implementation, method step 202 includes method step 500.

FIG. 6 depicts that, in one implementation, method step 202 can include method step 600.

FIG. 7 shows that, in one implementation, method step 600 includes method step 700; further depicted is that, in another implementation, method step 600 includes method step 702.

FIG. 8 shows that, in one implementation, method step 202 can include method step 800.

FIG. 9 shows that, in one implementation, method step 800 can include method step 900.

FIG. 10 shows that, in one implementation, method step 800 can include method step 1000.

FIG. 11 depicts that, in one implementation, method step 900 can include method step 1100.

FIG. 12 shows that, in one implementation, of method step 202 can include method step 1200.

FIG. 13 depicts a pictorial representation of a conventional data processing system in which illustrative embodiments of the devices and/or processes described herein may be implemented.

The use of the same reference symbols in different drawings indicates similar or identical items.

### DETAILED DESCRIPTION OF THE PREFERRED EMBODIMENT

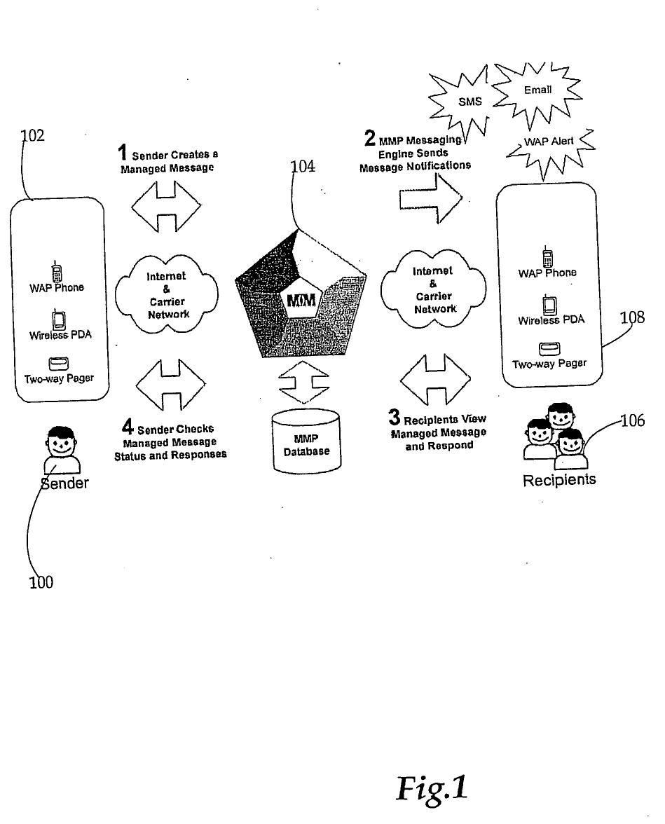

With reference now to FIG. 1, shown is a pictographic representation of an environment wherein methods and systems described herein may be utilized. First, depicted in FIG. 1 is that sender 100, by use of wireless device 102 creates a message via communication with Managed Messaging Platform (MMP) engine 104 (as shown, wireless device 102 may be any type of wireless device such as a Wireless Application Protocol (WAP) phone, a wireless Personal Digital Assistant (PDA), or a two-way pager). Second, illustrated is that MMP engine 104 sends message notifications to each wireless device 108 associated with each desired recipient forming group of desired recipients 106 (as shown, each wireless device 108 may be any type of wireless device such as a Wireless Application Protocol (WAP) phone, a wireless Personal Digital Assistant (PDA), or a two-way pager). Third, shown is that one or more desired recipients in group of desired recipients 106 view and/or respond to the message via communication with MMP engine 104, where such viewing and/or responding is achieved via each desired recipient's use of his or her respective wireless device 108. Fourth, depicted is that sender 100, via communication with MMP engine 104, uses his wireless device 102 to check the message status and responses, where the statuses and responses may have been aggregated by MMP engine 104. For more details related to the foregoing scheme, please see herein incorporated by reference Provisional Patent Application 60/282,381.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either substeps or additional steps building on one or more earlier-presented flowcharts. Those having ordinary skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations.

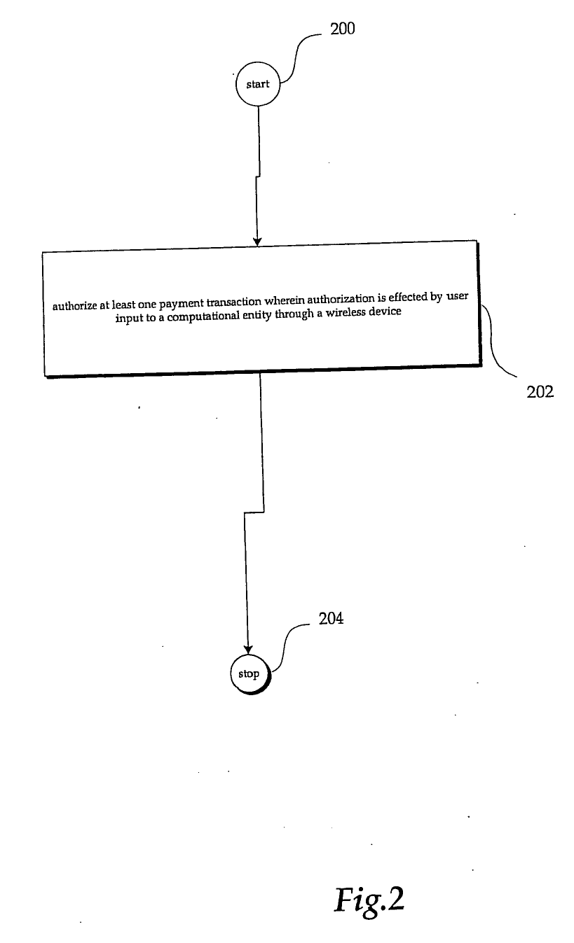

Referring now to FIG. 2, shown is a high-level logic flowchart depicting a process. Method step 200 depicts the start of process. Method step 202 illustrates authorizing at least one payment transaction wherein authorization is effected by user input to a computational entity through a wireless device. Method step 204 shows the end of the process. In one device implementation, method step 202 is achieved via wireless link between a wireless device (e.g., wireless device 102 of FIG. 1) and a wireless web server entity (e.g., a part of MMP engine 104 of FIG. 1), wherein a user (e.g., sender 100) inputs the authorization into a wireless web browser (e.g., a WAP browser), such input thereafter transmitted to the wireless web server entity via the wireless link.

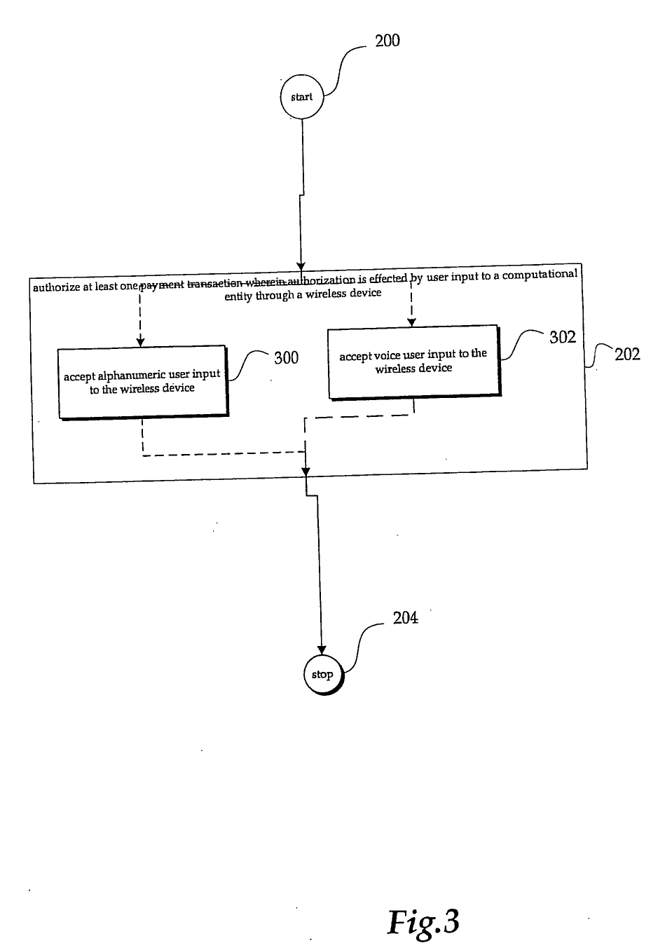

With reference now to FIG. 3, shown are two alternate implementations of the high-level logic flowchart shown in FIG. 2. Depicted in FIG. 3 is that, in one implementation, method step 202 includes method step 300; further depicted is that, in another implementation, method step 202 includes method step 302. Method step 300 shows that, in one implementation, authorizing at least one payment transaction wherein authorization is effected by user input to a computational entity through a wireless device can include, but is not limited to, accepting alphanumeric user input to the wireless device. In one device implementation, method step 300 is achieved via a user (e.g., sender 100) keying data input into a wireless web browser (e.g., a WAP browser) via a cell phone (e.g., wireless device 102) keyboard.

Method step 302 shows that, in one implementation, authorizing at least one payment transaction wherein authorization is effected by user input to a computational entity through a wireless device can include, but is not limited to, accepting voice user input to the wireless device. In one device implementation, method step 302 is achieved via a user (e.g., sender 100) speaking data input into a cell phone (e.g., wireless device 102) microphone.

For additional examples of the process of FIG. 3 and device implementations thereof, please see herein incorporated by reference Provisional Patent Application No. 60/282,381. The remaining method steps of FIG. 3 function substantially as described elsewhere herein.

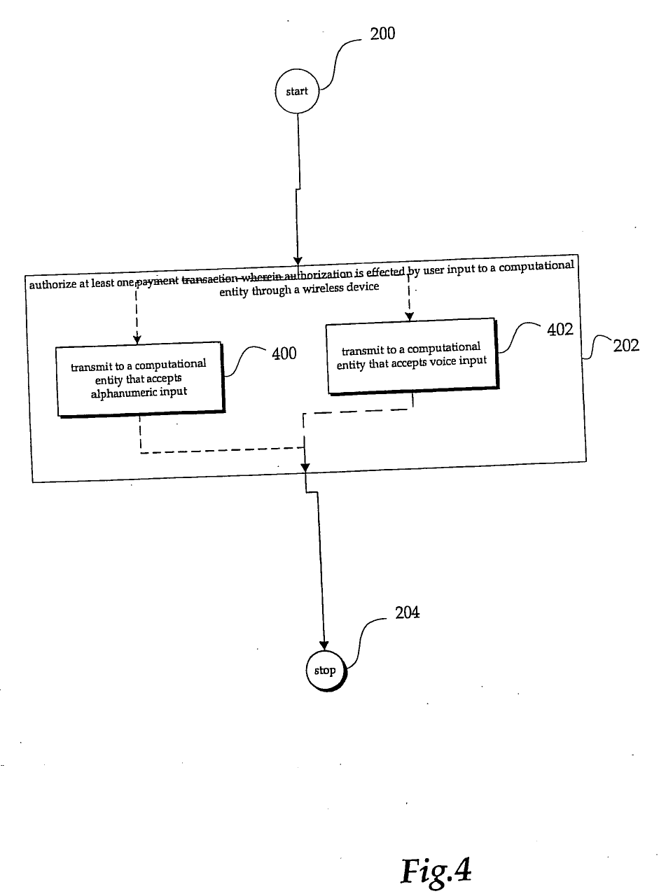

With reference now to FIG. 4, shown are two alternate implementations of the high-level logic flowchart shown in FIG. 2. Depicted in FIG. 4 is that, in one implementation, method step 202 includes method step 400; further depicted is that, in another implementation, method step 202 includes method step 402. Method step 400 shows that, in one implementation, authorizing at least one payment transaction wherein authorization is effected by user input to a computational entity through a wireless device can include, but is not limited to, transmitting to a computational entity that accepts alphanumeric input. In one device implementation, method step 400 is achieved via a wireless device (e.g., wireless device 102) transmitting to a wireless web server entity (e.g., a part of MMP engine 104 of FIG. 1) that understands and accepts alphanumeric input.

Method step 402 shows that, in one implementation, authorizing at least one payment transaction wherein authorization is effected by user input to a computational entity through a wireless device can include, but is not limited to, transmitting to a computational entity that accepts voice input. In one device implementation, method step 402 is achieved via a wireless device (e.g., wireless device 102) transmitting to a computational entity (e.g., a part of MMP engine 104 of FIG. 1) which understands and accepts voice input, and which thereafter processes the voice input and reformulates it into alphanumeric input and subsequently transmits the alphanumeric input to the wireless web server entity (e.g., a part of MMP engine 104 of FIG. 1) which understands and accepts alphanumeric input.

For additional examples of the process of FIG. 4 and device implementations thereof, please see herein incorporated by reference Provisional Patent Application No. 60/282,381. The remaining method steps of FIG. 4 function substantially as described elsewhere herein.

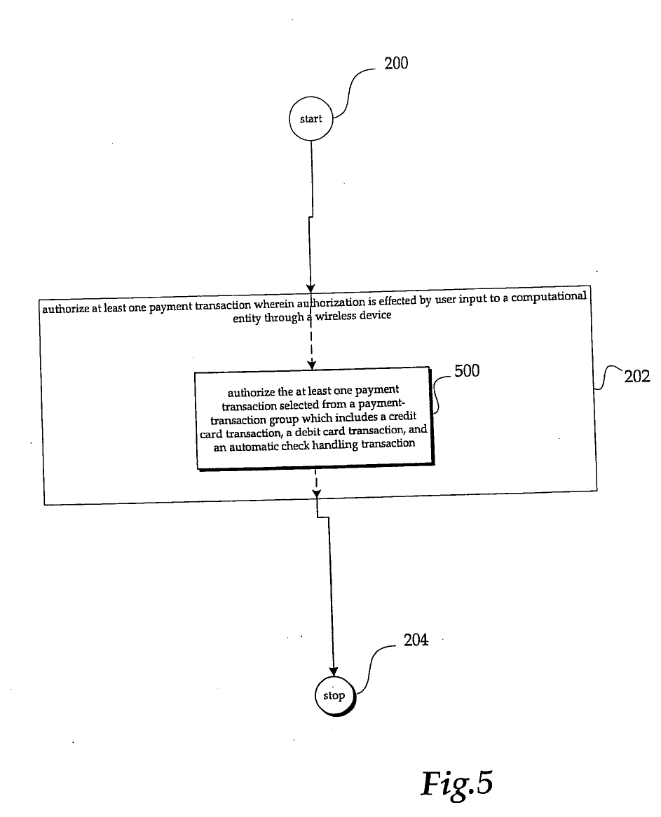

With reference now to FIG. 5, shown is an implementation of the high-level logic flowchart shown in FIG. 2. Depicted in FIG. 5 is that, in one implementation, method step 202 includes method step 500. Method step 500 shows that, in one implementation, authorizing at least one payment transaction wherein authorization is effected by user input to a computational entity through a wireless device can include, but is not limited to, authorizing the at least one payment transaction selected from the payment-transaction group which includes a credit card transaction, a debit card transaction, and an automatic check handling transaction. In one device implementation, method step 500 is achieved via a user (e.g., sender 100) keying payment-transaction information into a wireless web browser (e.g., a WAP browser) via a cell phone (e.g., wireless device 102). In another device implementation, method step 500 is achieved via a user (e.g., sender 100) speaking payment-transaction information into a cell phone (e.g., wireless device 102).

For additional examples of the process of FIG. 5 and device implementations thereof, please see herein incorporated by reference Provisional Patent Application No. 60/282,381. The remaining method steps of FIG. 5 function substantially as described elsewhere herein.

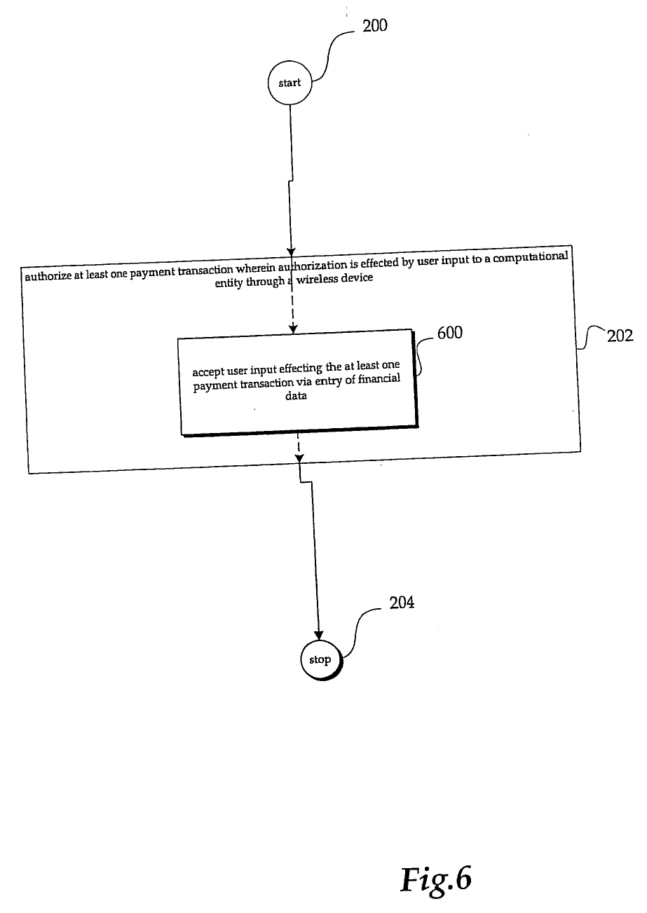

With reference now to FIG. 6, shown is an implementation of the high-level logic flowchart shown in FIG. 2. Depicted in FIG. 6 is that, in one implementation, method step 202 can include method step 600. Method step 600 shows that, in one implementation, authorizing at least one payment transaction wherein authorization is effected by user input to a computational entity through a wireless device can include, but is not limited to, accepting user input effecting the at least one payment transaction via entry of financial data. (For example, such as was at least partially described in herein incorporated by reference Provisional Patent Application No. 60/282,381.) The remaining method steps of FIG. 6 function substantially as described elsewhere herein

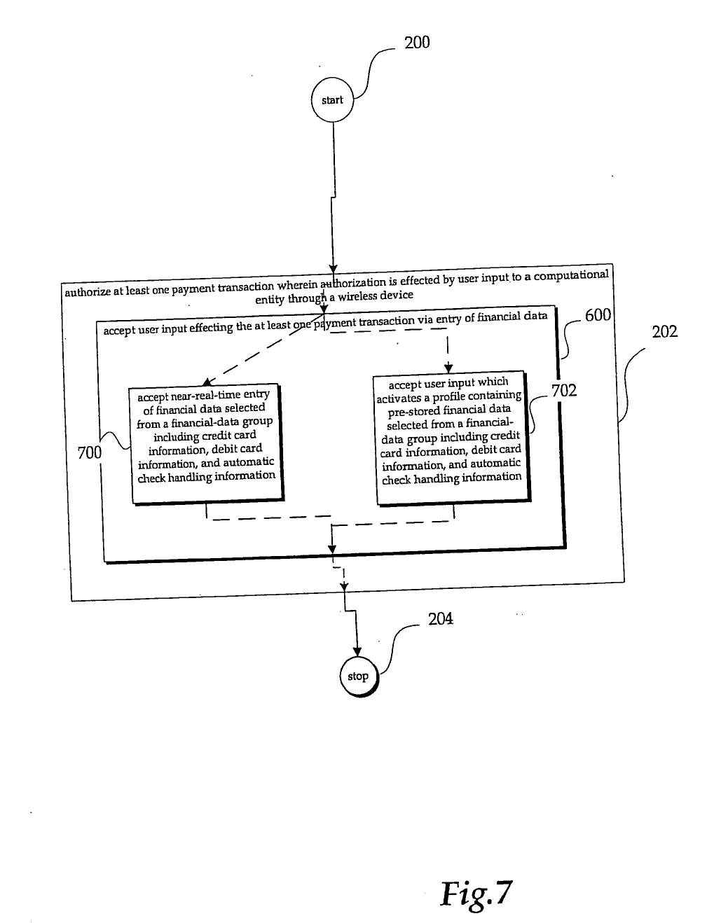

With reference now to FIG. 7, shown are two alternate implementations of the high-level logic flowchart shown in FIG. 6. Depicted in FIG. 7 is that, in one implementation, method step 600 includes method step 700; further depicted is that, in another implementation, method step 600 includes method step 702. Method step 700 shows that, in one implementation, accepting user input effecting the at least one payment transaction via entry of financial data can include, but is not limited to, accepting near-real-time entry of financial data selected from a financial-data group including, but not limited to, credit card information, debit card information, and automatic check handling information. In one device implementation, method step 700 is achieved via a user (e.g., sender 100) keying financial-data information into a wireless web browser (e.g., a WAP browser) via a cell phone (e.g., wireless device 102). In another device implementation, method step 700 is achieved via a user (e.g., sender 100) speaking financial-data information into a cell phone (e.g., wireless device 102).

Method step 702 shows that, in one implementation, accepting user input effecting the at least one payment transaction via entry of financial data can include, but is not limited to, accepting user input which activates a profile containing pre-stored financial data selected from a financial-data group including, but not limited to, credit card information, debit card information, and automatic check handling information. In one device implementation, method step 702 is achieved via a user (e.g., sender 100) keying profile information into a wireless web browser (e.g., a WAP browser) via a cell phone (e.g., wireless device 102). In another device implementation, method step 702 is achieved via a user (e.g., sender 100) speaking profile information into a cell phone (e.g., wireless device 102).

For additional examples of the process of FIG. 7 and device implementations thereof, please see herein incorporated by reference Provisional Patent Application No. 60/282,381. The remaining method steps of FIG. 7 function substantially as described elsewhere herein.

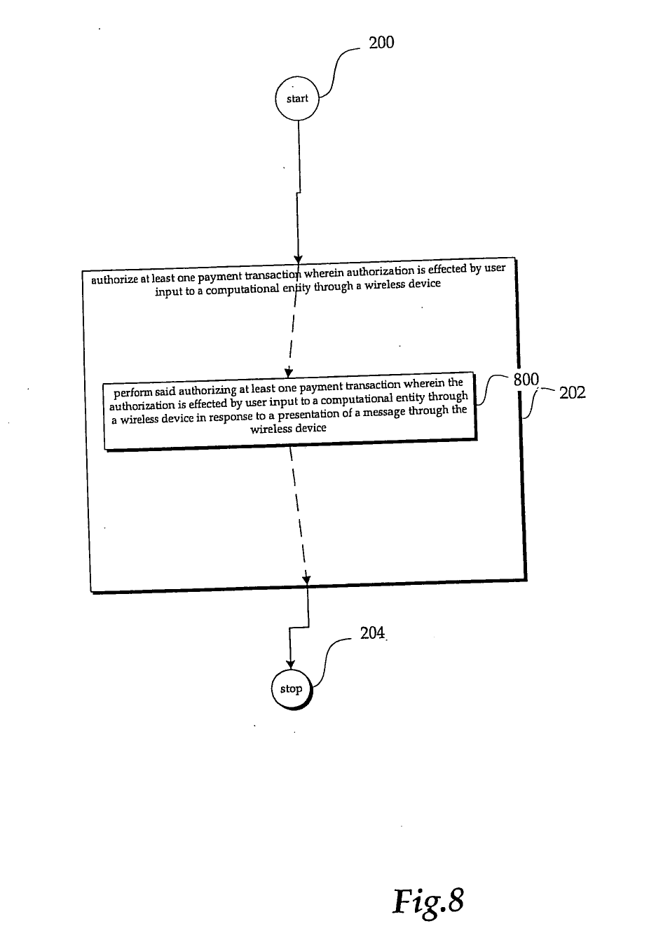

With reference now to FIG. 8, shown is an implementation of the high-level logic flowchart shown in FIG. 2. Depicted in FIG. 8 is that, in one implementation, method step 202 can include method step 800. Method step 800 shows that, in one implementation, authorizing at least one payment transaction wherein authorization is effected by user input to a computational entity through a wireless device can include, but is not limited to, performing said authorizing at least one payment transaction wherein authorization is effected by user input to a computational entity through a wireless device in response to a presentation of a message through the wireless device. In one device implementation, method step 800 is achieved via wireless link between a wireless device (e.g., wireless device 102 of FIG. 1) and a wireless web server entity (e.g., a part of MMP engine 104 of FIG. 1), whereby the wireless web server entity causes a notification of an event to be displayed to a user (e.g., sender 100) through the wireless device; thereafter, the user inputs, through the wireless device, the authorization into a wireless web browser (e.g., a WAP browser), such input thereafter transmitted to the wireless web server entity via the wireless link.

For additional examples of the process of FIG. 8 and device implementations thereof, please see herein incorporated by reference Provisional Patent Application No. 60/282,381. The remaining method steps of FIG. 8 function substantially as described elsewhere herein.

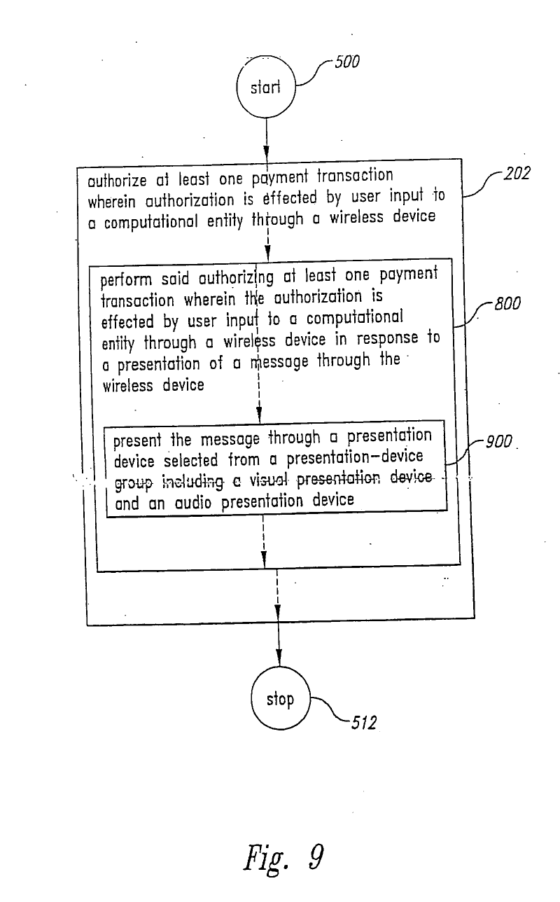

With reference now to FIG. 9, shown is an implementation of the high-level logic flowchart shown in FIG. 8. Depicted in FIG. 9 is that, in one implementation, method step 800 can include method step 900. Method step 900 shows that, in one implementation, performing said authorizing at least one payment transaction wherein authorization is effected by user input to a computational entity through a wireless device in response to a presentation of a message through the wireless device can include, but is not limited to, presenting the message through a presentation device selected from a presentation-device group including a visual presentation device and an audio presentation device. In one device implementation, method step 900 is achieved via a wireless device (e.g., wireless device 102 of FIG. 1) that has either or both audio and visual presentation capabilities.

For additional examples of the process of FIG. 9 and device implementations thereof, please see herein incorporated by reference Provisional Patent Application No. 60/282,381. The remaining method steps of FIG. 9 function substantially as described elsewhere herein.

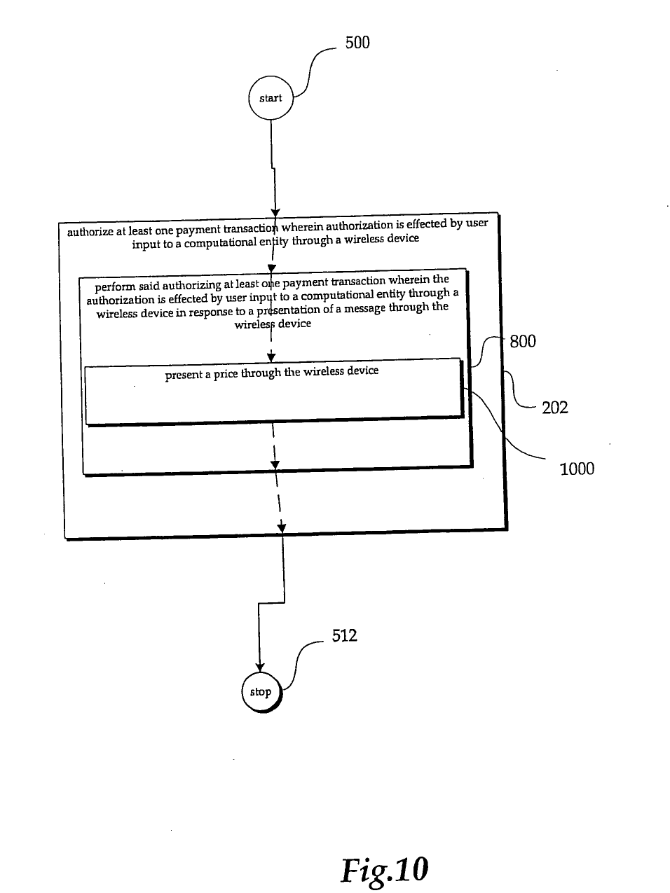

With reference now to FIG. 10, shown is an implementation of the high-level logic flowchart shown in FIG. 8. Depicted in FIG. 10 is that, in one implementation, method step 800 can include method step 1000. Method step 1000 shows that, in one implementation, performing said authorizing at least one payment transaction wherein authorization is effected by user input to a computational entity through a wireless device in response to a presentation of a message through the wireless device can include, but is not limited to, presenting a price through the wireless device. In one device implementation, method step 800 is achieved via wireless link between a wireless device (e.g., wireless device 102 of FIG. 1) and a wireless web server entity (e.g., a part of MMP engine 104 of FIG. 1), whereby the wireless web server entity causes a notification of an event having an associated price to be displayed to a user (e.g., sender 100) through the wireless device; thereafter, the user inputs, through the wireless device, the authorization into a wireless web browser (e.g., a WAP browser), such input thereafter transmitted to the wireless web server entity via the wireless link.

For additional examples of the process of FIG. 10 and device implementations thereof, please see herein incorporated by reference Provisional Patent Application No. 60/282,381. The remaining method steps of FIG. 10 function substantially as described elsewhere herein.

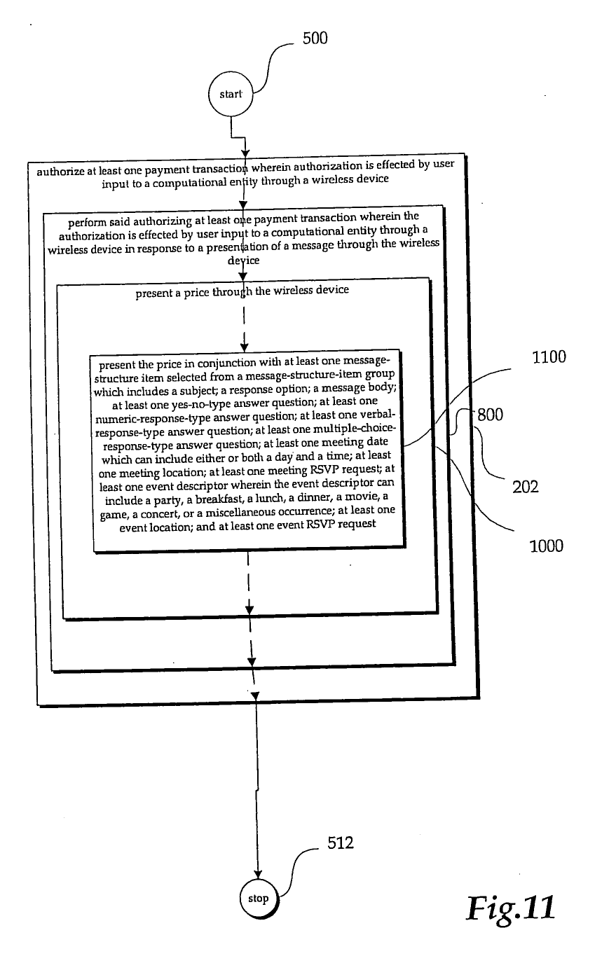

With reference now to FIG. 11, shown is an implementation of the high-level logic flowchart shown in FIG. 10. Depicted in FIG. 11 is that, in one implementation, method step 900 can include method step 1100. Method step 1100 shows that, in one implementation, presenting a price through the wireless device can include, but is not limited to, presenting the price in conjunction with at least one message-structure item selected from a message-structure-item group which includes a subject; a response option; a message body; at least one yes-no-type answer question; at least one numeric-response-type answer question; at least one verbal-response-type answer question; at least one multiple-choice-response-type answer question; at least one “meeting” date which can include either or both a day and a time; at least one meeting location; at least one meeting RSVP request; at least one event descriptor wherein the “event” descriptor can include a party, a breakfast, a lunch, a dinner, a movie, a game, a concert or a miscellaneous occurrence; at least one event location; and at least one event RSVP request. In one device implementation, method step 1100 is achieved via wireless link between a wireless device (e.g., wireless device 102 of FIG. 1) and a wireless web server entity (e.g., a part of MMP engine 104 of FIG. 1), whereby the wireless web server entity causes a price in conjunction with at least one message-structure item to be displayed to a user (e.g., sender 100) through the wireless device.

For additional examples of the process of FIG. 11 and device implementations thereof, please see herein incorporated by reference Provisional Patent Application No. 60/282,381. The remaining method steps of FIG. 11 function substantially as described elsewhere herein.

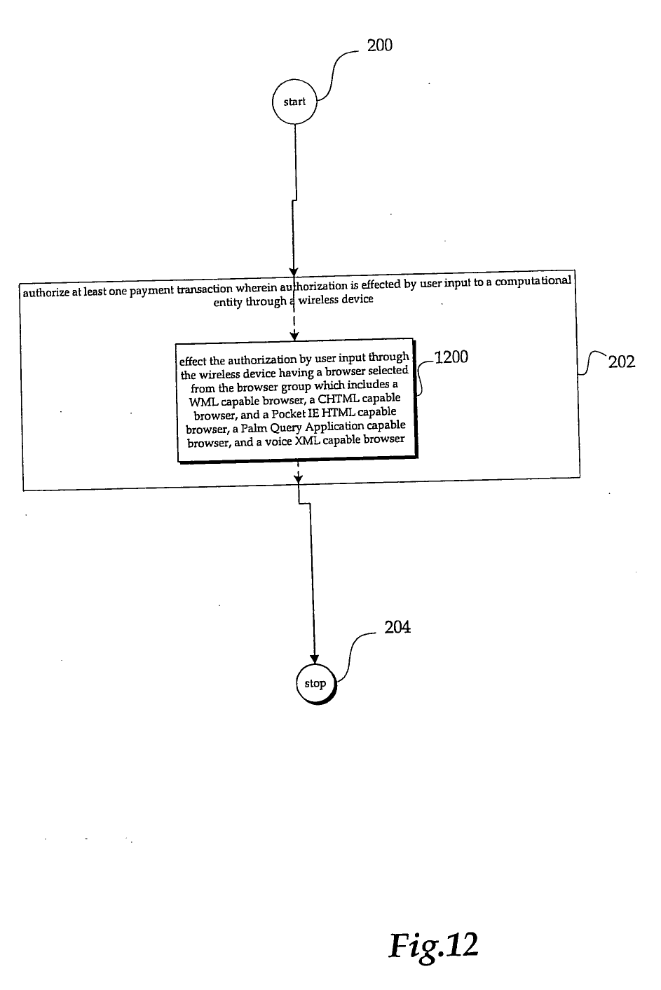

With reference now to FIG. 12, shown is an implementation of the high-level logic flowchart shown in FIG. 2. Depicted in FIG. 12 is that, in one implementation, method step 202 can include method step 1200. Method step 1200 shows that, in one implementation, authorizing at least one payment transaction wherein authorization is effected by user input through a wireless device can include, but is not limited to, effecting the authorization by user input through the wireless device having a browser selected from the browser group which includes a WML (Wireless Markup Language) capable browser, a CHTML (Compact Hypertext Markup Language) capable browser, a Pocket IE (Internet Explorer) HTML (Compact Hypertext Markup Language) capable browser, a Palm Query Application capable browser, and a voice XML (Extensible Markup Language) capable browser. Those skilled in the art will appreciate that the foregoing wireless-device group is not exhaustive, but rather exemplary. The remaining method steps of FIG. 12 function substantially as described elsewhere herein.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or any combination thereof. In one embodiment, the present invention may be implemented via Application Specific Integrated Circuits (ASICs). However, those skilled in the art will recognize that the embodiments disclosed herein, in whole or in part, can be equivalently implemented in standard Integrated Circuits, as one or more computer programs running on one or more computers (e.g., as one or more server programs running on one or more computer systems), as one or more programs running on one or more processors (e.g., as one or more thin client programs running on one or more processors), as firmware, or as virtually any combination thereof, and that designing the circuitry and/or writing the code for the software or firmware would be well within the skill of one of ordinary skill in the art in light of this disclosure. In addition, those skilled in the art will appreciate that the mechanisms of the present invention are capable of being distributed as a program product in a variety of forms, and that an illustrative embodiment of the present invention applies equally regardless of the particular type of signal bearing media used to actually carry out the distribution. Examples of a signal bearing media include, but are not limited to, the following: recordable type media such as floppy disks, hard disk drives, CD ROMs, digital tape, and transmission type media such as digital and analogue communication links using TDM or IP based communication links (e.g., packet links).

In a general sense, those skilled in the art will recognize that the various embodiments described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configurable by a computer program (e.g., a general purpose computer configurable by a computer program or a microprocessor configurable by a computer program), electrical circuitry forming a memory device (e.g., any and all forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation. FIG. 33 shows an example representation of a data processing system into which at least a part of the herein described devices and/or processes may be integrated with a reasonable amount of experimentation.

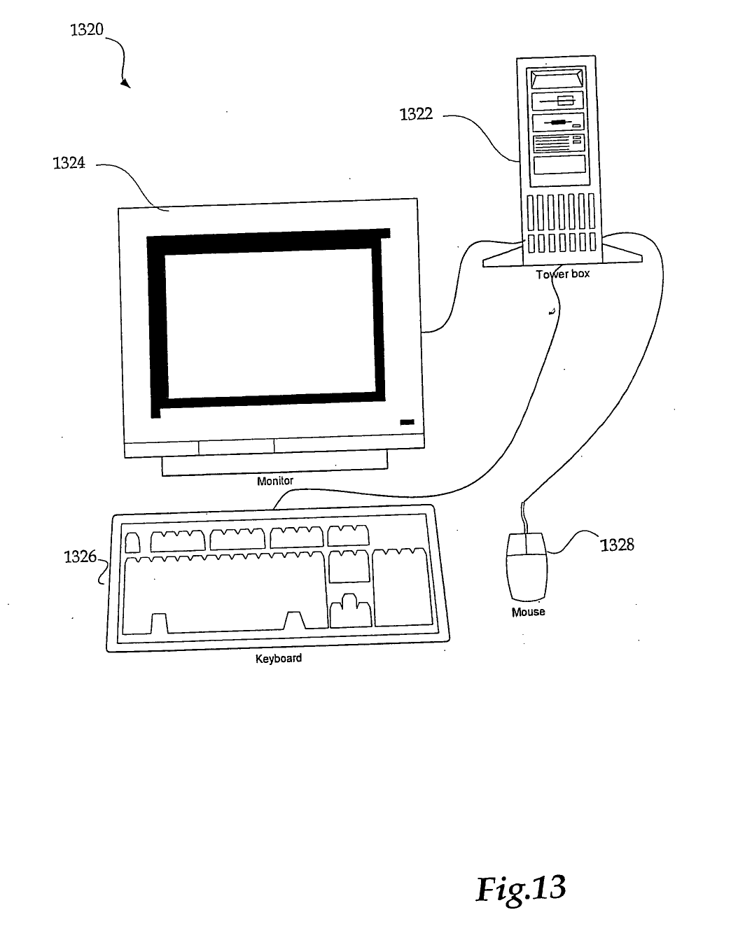

With reference now to FIG. 13, depicted is a pictorial representation of a conventional data processing system in which illustrative embodiments of the devices and/or processes described herein may be implemented. It should be noted that a graphical user interface systems (e.g., Microsoft Windows 98 or Microsoft Windows NT operating systems) and methods can be utilized with the data processing system depicted in FIG. 13. Data processing system 1320 is depicted which includes system unit housing 1322, video display device 1324, keyboard 1326, mouse 1328, and microphone (not shown). Data processing system 1320 may be implemented utilizing any suitable computer such as a DELL portable computer system, a product of Dell Computer Corporation, located in Round Rock, Tex.; Dell is a trademark of Dell Computer Corporation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will also be understood by those within the art that if a specific number of an introduced claim element is intended, such an intent will be explicitly recited in the claim, and in the absence of such recitation no such intent is present. For example, as an aid to understanding, the following appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use of definite articles used to introduce claim elements. In addition, even if a specific number of an introduced claim element is explicitly recited, those skilled in the art will recognize that such recitation should typically be interpreted to mean at least the recited number (e.g., the bare recitation of “two elements,” without other modifiers, typically means at least two elements, or two or more elements).

1. A method comprising:
presenting an offer to engage in a financial transaction through a wireless device; and
accepting input associated with the offer to engage in the financial transaction through the wireless device.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A system comprising:
circuitry for presenting an offer to engage in a financial transaction through a wireless device, said circuitry selected from an electrical-circuitry group including electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, and/or electrical circuitry forming a communications device; and
circuitry for accepting input associated with the offer to engage in the financial transaction through the wireless device, said circuitry selected from an electrical-circuitry group including electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, and/or electrical circuitry forming a communications device.

24. (canceled)

25. The system of claim 23, wherein said means for accepting input associated with the offer to engage in the financial transaction through the wireless device comprises:
means for accepting voice input to the wireless device.

26. (canceled)

27. (canceled)

28. The system of claim 23, wherein said means for accepting input associated with the offer to engage in the financial transaction through the wireless device comprises:
means for accepting input authorizing a credit card transaction.

29. The system of claim 23, wherein said means for accepting input associated with the offer to engage in the financial transaction through the wireless device comprises:
means for accepting input authorizing a debit card transaction.

30. The system of claim 23, wherein said means for accepting input associated with the offer to engage in the financial transaction through the wireless device comprises:
means for accepting input associated with authorizing an automatic check handling transaction.

31. The system of claim 23, wherein said means for accepting input associated with the offer to engage in the financial transaction through the wireless device comprises:
means for accepting input associated with entry of financial data.

32. The system of claim 31, wherein said means for accepting input associated with entry of financial data comprises:
means for accepting near-real-time entry of credit card information.

33. The system of claim 31, wherein said means for accepting input associated with entry of financial data comprises:
means for accepting near-real-time entry of debit card information.

34. The system of claim 31, wherein said means for accepting input associated with entry of financial data comprises:
means for accepting near-real-time entry of automatic check handling information.

35. The system of claim 31, wherein said means for accepting input associated with entry of financial data comprises:
means for accepting input representative of a profile containing pre-stored financial data.

36. The system of claim 35, wherein said means for accepting input representative of a profile containing pre-stored financial data comprises:
means for accepting input representative of a profile containing pre-stored credit card information.

37. The system of claim 35, wherein said means for accepting input representative of a profile containing pre-stored financial data comprises:
means for accepting input representative of a profile containing pre-stored debit card information.

38. The system of claim 35, wherein said means for accepting input representative of a profile containing pre-stored financial data comprises:
means for accepting input representative of a profile containing pre-stored automatic check handling information.

39. The system of claim 23, wherein said means for accepting input associated with the offer to engage in the financial transaction through the wireless device comprises:
means for accepting input to the wireless device responsive to presentation of a message-structure item through the wireless device.

40. The system of claim 23, wherein said means for presenting an offer to engage in a financial transaction through a wireless device comprises:
means for presenting a message-structure item through a presentation device selected from a presentation-device group including a visual presentation device and an audio presentation device.

41. The system of claim 23, wherein the said means for presenting an offer to engage in a financial transaction through a wireless device comprises:
means for presenting a price through the wireless device.

42. The system of claim 41, wherein said means for presenting a price through the wireless device comprises:
means for presenting the price in conjunction with at least one message-structure item.

43. The system of claim 42, wherein said means for presenting the price in conjunction with at least one message-structure item comprises:
means for presenting the price in conjunction with a subject; a response option; a message body; at least one yes-no-type answer question; at least one numeric-response-type answer question; at least one verbal-response-type answer question; at least one multiple-choice-response-type answer question; at least one meeting date which can include either or both a day and a time; at least one meeting location; at least one meeting RSVP request; at least one event descriptor wherein the event descriptor can include a party, a breakfast, a lunch, a dinner, a movie, a game, a concert, or a miscellaneous occurrence; at least one event location; or at least one event RSVP request.

44. (canceled)

45. A system comprising:
means for presenting an offer to engage in a financial transaction through a wireless device, said circuitry selected from an electrical-circuitry group including electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, and/or electrical circuitry forming a communications device; and
means for accepting input associated with the offer to engage in the financial transaction through the wireless device, said circuitry selected from an electrical-circuitry group including electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, and/or electrical circuitry forming a communications device.

46. A system comprising:
circuitry for transmitting an offer to engage in a financial transaction to a wireless device; and
circuitry for receiving a signal associated with the offer to engage in the financial transaction.

47. (canceled)

48. The system of claim 46, wherein said circuitry for receiving a signal associated with the offer to engage in the financial transaction comprises:
circuitry for receiving a signal indicative of a voice input to the wireless device.

49. The system of claim 46, wherein said circuitry for receiving a signal associated with the offer to engage in the financial transaction comprises:
circuitry for receiving a signal indicative of an authorization of a credit card transaction.

50. The system of claim 46, wherein said circuitry for receiving a signal associated with the offer to engage in the financial transaction comprises:
circuitry for receiving a signal indicative of an authorization of a debit card transaction.

51. The system of claim 46, wherein said circuitry for receiving a signal associated with the offer to engage in the financial transaction comprises:
circuitry for receiving a signal indicative of an authorization of an automatic check handling transaction.

52. The system of claim 46, wherein said circuitry for receiving a signal associated with the offer to engage in the financial transaction comprises:
circuitry for receiving a signal indicative of an entry of financial data.

53. The system of claim 52, wherein said circuitry for receiving a signal indicative of an entry of financial data comprises:
circuitry for receiving a signal indicative of near-real-time entry of credit card information.

54. The system of claim 52, wherein said circuitry for receiving a signal indicative of an entry of financial data comprises:
circuitry for receiving a signal indicative of near-real-time entry of debit card information.

55. The system of claim 52, wherein said circuitry for receiving a signal indicative of an entry of financial data comprises:
circuitry for receiving a signal indicative of near-real-time entry of automatic check handling information.

56. The system of claim 52, wherein said circuitry for receiving a signal indicative of an entry of financial data comprises:
circuitry for receiving a signal indicative of a profile containing pre-stored financial data.

57. The system of claim 56, wherein said circuitry for receiving a signal indicative of a profile containing pre-stored financial data comprises:
circuitry for receiving a signal indicative of a profile containing pre-stored credit card information.

58. The system of claim 56, wherein said circuitry for receiving a signal indicative of a profile containing pre-stored financial data comprises:
circuitry for receiving a signal indicative of a profile containing pre-stored debit card information.

59. The system of claim 56, wherein said circuitry for receiving a signal indicative of a profile containing pre-stored financial data comprises:
circuitry for receiving a signal indicative of a profile containing pre-stored automatic check handling information.

60. The system of claim 46, wherein said circuitry for transmitting an offer to engage in a financial transaction to a wireless device further comprises:
circuitry for transmitting a signal associated with presentation of a message through the wireless device.

61. The system of claim 60, wherein said circuitry for transmitting a signal associated with presentation of a message through the wireless device comprises:
circuitry for transmitting a signal associated with presentation of a price through the wireless device.

62. The system of claim 61, wherein said circuitry for transmitting a signal associated with presentation of a price through the wireless device comprises:
circuitry for transmitting a signal associated with presentation of the price in conjunction with at least one message-structure item.

63. The system of claim 62, wherein said circuitry for transmitting a signal associated with presentation of the price in conjunction with at least one message-structure item comprises:
circuitry for transmitting a signal associated with presentation of the price in conjunction with a subject; a response option; a message body; at least one yes-no-type answer question; at least one numeric-response-type answer question; at least one verbal-response-type answer question; at least one multiple-choice-response-type answer question; at least one meeting date which can include either or both a day and a time; at least one meeting location; at least one meeting RSVP request; at least one event descriptor wherein the event descriptor can include a party, a breakfast, a lunch, a dinner, a movie, a game, a concert, or a miscellaneous occurrence; at least one event location; or at least one event RSVP request.

64. (canceled)

65. A method comprising:
transmitting an offer to engage in a financial transaction to a wireless device; and
receiving a signal associated with the offer to engage in the financial transaction.

66. The method of claim 65, wherein said receiving a signal associated with the offer to engage in the financial transaction comprises:
receiving a signal indicative of an authorization of a credit card transaction.

67. The method of claim 65, wherein said receiving a signal associated with the offer to engage in the financial transaction comprises:
receiving a signal indicative of an authorization of a debit card transaction.

68. The method of claim 65, wherein said receiving a signal associated with the offer to engage in the financial transaction comprises:
receiving a signal indicative of an authorization of an automatic check handling transaction.

69. The method of claim 65, wherein said receiving a signal associated with the offer to engage in the financial transaction comprises:
receiving a signal indicative of an entry of financial data.

70. The method of claim 69, wherein said receiving a signal indicative of entry of financial data comprises:
receiving a signal indicative of a profile containing pre-stored financial data.

71. The method of claim 70, wherein said receiving a signal indicative of a profile containing pre-stored financial data comprises:
receiving a signal indicative of a profile containing pre-stored credit card information.

72. The method of claim 70, wherein said receiving a signal indicative of a profile containing pre-stored financial data comprises:
receiving a signal indicative of a profile containing pre-stored debit card information.

73. The method of claim 70, wherein said receiving a signal indicative of a profile containing pre-stored financial data comprises:
receiving a signal indicative of a profile containing pre-stored automatic check handling information.

74. The method of claim 65, transmitting an offer to engage in a financial transaction to a wireless device further comprises:
transmitting a signal associated with presentation of a message through the wireless device.

75. The method of claim 74, wherein said transmitting a signal associated with presentation of a message through the wireless device comprises:
transmitting a signal associated with presentation of a price through the wireless device.

76. The method of claim 75, wherein said transmitting a signal associated with presentation of a price through the wireless device comprises:
transmitting a signal associated with presentation of the price in conjunction with at least one message-structure item.

77. The method of claim 76, wherein said transmitting a signal associated with presentation of the price in conjunction with at least one message-structure item comprises:
transmitting a signal associated with presentation of the price in conjunction with a subject; a response option; a message body; at least one yes-no-type answer question; at least one numeric-response-type answer question; at least one verbal-response-type answer question; at least one multiple-choice-response-type answer question; at least one meeting date which can include either or both a day and a time; at least one meeting location; at least one meeting RSVP request; at least one event descriptor wherein the event descriptor can include a party, a breakfast, a lunch, a dinner, a movie, a game, a concert, or a miscellaneous occurrence; at least one event location; or at least one event RSVP request.

78. A system comprising:
means for transmitting an offer to engage in a financial transaction to a wireless device; and
means for receiving a signal associated with the offer to engage in the financial transaction.
